(19) United States
(12) Patent Application Publication
(10) Pub. No.: US 2004/0114515 A1
(43) Pub. Date: Jun. 17, 2004

(54) VoIP call control apparatus in private branch exchange and method thereof

(76) Inventor: Jung-Gi Kim, Suwon-city (KR)

Correspondence Address: Robert E. Bushnell, Suite 300, 1522 K Street, N.W., Washington, DC, 20005, US

(21) Appl. No.: 10/727,641

(22) Filed: Dec. 5, 2003

(30) Foreign Application Priority Data
Dec. 13, 2002 (KR) 2002-79836

(51) Int. Cl. H04L 12/26

(52) U.S. Cl. 370/230

(57) ABSTRACT

A VoIP call control apparatus in a PBX (Private Branch exchange) and a method thereof is capable of an effective charge management by differentiating bandwidth allocation according to a service level. The VoIP call control apparatus in a PBX includes: a service class decision unit for receiving a VoIP call service request from a subscriber, deciding a service class, and outputting the service class; a service level decision unit for measuring a service level of a VoIP trunk and outputting the service level; a C/O matching unit for matching a PSTN network and the PBX; a VoIP gateway for performing a protocol matching process with respect to an outgoing call from the PBX, and providing a voice call conforming to VoIP protocol; a G/W matching unit for matching the VoIP gateway and the PBX; and a signal processing unit for deciding whether the VoIP call with the service class transmitted from the service decision unit can be serviced in the service level of the VoIP trunk transmitted from the service level decision unit, and if the VoIP call is serviceable, providing a VoIP call service through the G/W matching unit and the VoIP gateway, and if the VoIP call is not serviceable, providing a voice call service over the PSTN network via the C/O matching unit.

### CLAIM OF PRIORITY

This application makes reference to, incorporates the same herein, and claims all benefits accruing under 35 U.S.C. §119 from an application for “Call Control Apparatus in Private Branch exchange and Method Thereof” earlier filed in the Korean Intellectual Property Office on 13 Dec. 2002 and there duly assigned Serial No. 2002-79836.

### BACKGROUND OF THE INVENTION

1. Field of the Invention

The present invention generally relates to a VoIP (Voice over Internet Protocol) call control apparatus in a PBX (Private Branch exchange) and a method thereof, and more particularly, to a VoIP call control apparatus in a PBX, capable of an effective charge management by differentiating bandwidth allocation according to a service level, and a method thereof.

2. Description of Related Art

In general, a PBX or a keyphone system refers to a telephone exchange facility (e.g. interphone-to-telephone connection or telephone-to-interphone connection) established in government and public offices, corporations, or hospitals.

In the PBX, an extension telephone is accessed to a SLIC (Subscriber Line Interface Card) accommodating local subscribers, and a trunk card is accessed to a CO Line (Central Office Line) connected to a public exchange. Thus, a plurality of local subscribers can exchange calls with each other without going through an external central office line, and when they want to call outside, they simply need to press a trunk access code (usually, No. ‘9’) and dial a telephone number they intended to call.

Generally, a subscriber's extension line accessed to the PBX is composed of an extension line for covering general analog telephones, a keyphone line for covering keyphone telephones, an ISDN BRI (ISDN Basic Rate Interface) for covering ISDN (Integrated Services Digital Network) 11 telephones, and so forth. These lines are connected to a backboard of a matching device mounted in each PBX.

Central office line accessed to the PBX includes analog trunk (general CO line), digital trunk including E1 line (a high speed communication line according to a European specification and one of the E-carrier systems) or T1 (a high speed communication line and one of the T-carrier systems), ISDN PRI (ISDN Primary Rate Interface) line and the like. Again, these lines are connected to the backboard of the matching device mounted in the PBX.

Originally, VoIP referred to an IP telephone technique for sets of equipments for transferring voice information using an IP (Internet Protocol). Currently, VoIP indicates digitalized voice information transfer to discontinuous packets in a digital system, unlike traditional protocols based on a circuit such as PSTN (Public Switched Telephone Network).

The best advantage of VoIP and Internet telephone technique is integrated implementation of telephone services utilizing an existing IP network. In other words, telephone users are provided with long-distance and international telephone services in Internet, and Intranet environments at the Internet access charge only.

In case of having voice calls through the VoIP, because the public network cannot provide the quality of service (QoS) equivalent to one in a circuit network, a private network managed by a special business or Internet phone service operator (hereinafter, referred to as ‘special category telecommunications operator’) is preferred to get high-quality services.

In such case, the special category telecommunications operator has a server for managing IP addresses according to telephone numbers of the other parties. Hence, the user does not need to manage an IP address for the other party's telephone number every time he/she makes a voice call over the Internet.

To use VoIP in the PBX, a gateway is required. The gateway is in charge of receiving voice data packets from users and transferring them to destinations over networks, including Internet and Intranet, and directly connecting a corresponding call to PSTN using an analog trunk, or T1 or E1 interface.

Typically, in the case of accessing VoIP gateway to the PBX, the central office line accessed to the Vo/P gateway from the PBX is isolated and different access codes are given.

For instance, if an extension subscriber wants to make an outbound voice call through the VoIP gateway, ‘8’ can be assigned as the trunk access code, and if an extension subscriber wants to make an outbound call through a general CO line connected to the PSTN, ‘9’ can be assigned as the trunk access code, thereby distinguishing these codes.

In addition, if an extension subscriber wants to make a voice call through the VoIP gateway, only outgoing calls are possible in the communication with the other party using the VoIP, and incoming calls are available for the CO line.

To make a VoIP call, a user first needs to check the dial tone from the PBX, and dials a number for connection to the VoIP gateway between TCP (Transmission Control Protocol) and IP (Internet Protocol) network (Internet).

At this time, the VoIP gateway looks up a routing table to find out if the input number is a serviceable number.

If not, the VoIP gateway checks whether it is necessary to connect the call through another VoIP gateway. If this is not the case, the VoIP gateway returns corresponding information back to the PBX, to encourage making the call through a general telephone network.

If the VoIP gateway finds an Internet route corresponding to the input number, the call is connected. To do so, the gateway should secure a circuit between itself and the VoIP gateway of the other party.

After that, the VoIP gateway of the caller modulates the voice of the caller to an IP packet, as if it were transferring a corresponding data packet, and sends the corresponding IP packet to a given route over the TCP/IP network.

Meanwhile, receiving the IP packet data, the VoIP gateway on the receiving side recovers an analog signal by recombining packet information, and routes the restored signal to a call through the PSTN in the exchange office or through another PBX, and connects the call directly to a receiving telephone. In this manner, the voice call routing procedure over Internet is completed.

Taking advantage of VoIP techniques, network operators are able to route telephone calls over the network, just like using for data, and based on this, provide users with VoIP call services at a low price.

In many cases, a VoIP network is established between the headquarters of a company and branches, to reduce phone charges. The VoIP services available over this VoIP are as follows:

Long-distance calls between the headquarters and branches using IP network;

Long-distance calls between the headquarters and branches using PSTN network; and

International calls between the headquarters and branch subscribers through an international gateway office of international telephone network connected to PSTN (cf. the connection between the headquarters and branches is established through IP network).

At this time, if a subscriber accessed to each PBX tries to make a long-distance call or an international call, IP-PBX allocates a VoIP port and provides VoIP services in sequence, as long as a serviceable VoIP trunk exists.

However, there are not as many VoIP trunk ports as subscribers. Therefore, allocating one VoIP trunk port to five subscribers (Subscriber: VoIP trunk port=5:1), all subscribers can use the VoIP trunk port. Nevertheless, as VoIP calls increase, more VoIP trunk ports will have to be allocated and then it will be all in a busy state.

In such case, the subscribers cannot use VoIP calls because there is no available VoIP trunk for them, but use a relatively expensive PSTN trunk.

Moreover, if long-distance VoIP calls, which are not cost-effective compared to international VoIP calls, are involved, international call services are not going to be provided for a following VoIP call. As a result, from the perspective of cost-reduction through VoIP trunks of IP-PBX, it seems like a plurality of “inexpensive calls” occupies “inexpensive lines” and “expensive calls” cannot use “inexpensive lines” after all.

### SUMMARY OF THE INVENTION

An object of the invention is to solve at least the above problems and/or disadvantages and to provide at least the advantages described hereinafter.

Accordingly, one object of the present invention is to solve the foregoing problems by providing a method for controlling VoIP calls in PBX, to take advantage of a VoIP trunk that is relatively cost-effective in the PBX having subscribers, PSTN trunks and VoIP trunks.

Another object of the present invention is to provide a method for controlling VoIP calls in PBX, wherein VoIP service levels are defined according to the state of a VoIP call service, and cost-effective VoIP call services are controlled, depending on class of service per VoIP service level.

Still another object of the present invention is to provide a method for controlling VoIP calls in PBX, wherein cost-effective VoIP services are controlled in accordance with kind of call (e.g. international call, long-distance call, headquarters-to-branch call) per VoIP service level.

The foregoing and other objects and advantages are realized by providing a VoIP call control apparatus in a PBX (Private Branch eXchange), the apparatus including: a service class decision unit for receiving a VoIP call service request from a subscriber, deciding a service class, and outputting the service class; a service level decision unit for measuring a service level of a VoIP trunk and outputting the service level; a C/O (central office) matching unit for matching a PSTN network and the PBX; a VoIP gateway for performing a protocol matching process with respect to an outgoing call from the PBX, and providing a voice call conforming to VoIP protocol; a G/W (gateway) matching unit for matching the VoIP gateway and the PBX; and a signal processing unit for deciding whether the VoIP call with the service class transmitted from the service decision unit can be serviced or established in a service level of the VoIP trunk decided in the service level transmitted from the service level decision unit, and if the VoIP call is serviceable, providing a VoIP call service through the G/W matching unit and the VoIP gateway, and if the VoIP call is not serviceable, providing a voice call service over the PSTN network via the CIO matching unit.

Another aspect of the invention provides a VoIP call control method in a PBX (Private Branch exchange), the method including the steps of: in the PBX, if a subscriber sends a VoIP call service request, deciding a VoIP service class; deciding whether the VoIP call service can be provided in a VoIP trunk service level corresponding to the VoIP service class; if the VoIP call service cannot be provided, providing a voice call service through a PSTN network, and if the VoIP call service can be provided, looking up an available VoIP trunk port and providing the VoIP call service through the VoIP trunk; and when providing the VoIP call service, changing the VoIP trunk service level.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating a VoIP network architecture to which the present invention is applied;

FIG. 2 is a schematic diagram of a VoIP call control apparatus in a PBX according to an exemplary embodiment of the present invention; and

FIG. 3 is a flow chart describing a method for controlling VoIP calls in a PBX according to an exemplary embodiment of the present invention.

### DETAILED DESCRIPTION OF EXEMPLARY EMBODIMENTS

Reference will now be made in detail to exemplary embodiments of the present invention, which are illustrated in the accompanying drawings.

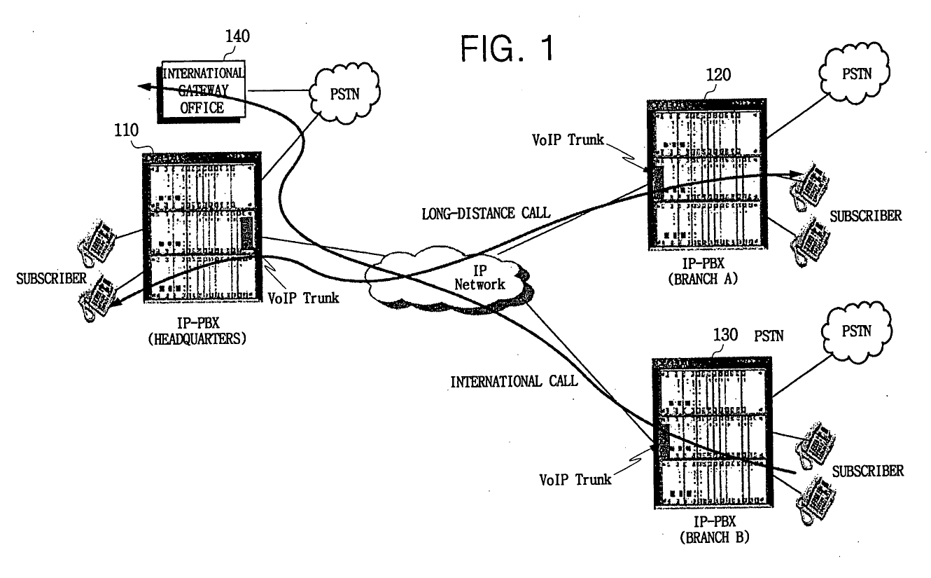

FIG. 1 is a diagram illustrating a VoIP network architecture to which the present invention is applied.

Referring to FIG. 1, the PBX 110 in the headquarters has a VoIP trunk, and is connected to an IP network and a PSTN network. Also, the PBX 110 is connected to an international gateway office 140 via the PSTN network.

In like manner, each of branch PBXs 120 and 130 has a VoIP trunk, respectively, and is connected to the IP network and the outbound PSTN network.

Thus, telephone communications between the headquarters and branches over IP network are possible through PBXs 110, 120 and 130 mounted with VoIP trunks. Telephone communications between branches are also possible using the PBXs 120 and 130 with VoIP trunks.

At this time, the headquarters and each of the branches are assigned with a necessary bandwidth, for example, 512 kbps (kilobits per second) to the headquarters and 256 kbps to each branch.

Moreover, each of the PBXs 110, 120 and 130 is interconnected with the PSTN network, and thus, PSTN network based-telephone communications between a branch and another branch, and between the headquarters and a branch are possible.

Because the PBX 110 of the headquarters is connected to the international gateway office 140 via the PSTN network, each of the branches can make international calls through the international gateway office 140 via its own PBX 120 or 130 and the PBX 110 of the headquarters.

Of course, long-distance call services are also available through the PBX 110 of the headquarters and the PBXs 120 and 130 of the branches.

Each of the PBXs 110, 120 and 130 defines a class of service associated with a VoIP call per subscriber. For example, the class of service for subscribers who make international and long-distance calls frequently is ‘0’ (e.g. Export Dept.), and the class of service for subscribers who make long-distance calls frequently is ‘1’ (e.g. Domestic Marketing Dept.).

In addition, the class of service for subscribers who make long-distance calls between the headquarters and a branch for most of the time is ‘2’ (e.g. Manufacture Management Dept.). Lastly, the class of service for other subscribers is ‘3’.

Next, a network bandwidth is assigned to each of the PBXs 110, 120 and 130 (refer to Table 1) (for instance, Silence Enable to G723.1 Codec (coder/decoder), and 8.3 kbps to the Multiframe 1 environment). Every time a VoIP call service is provided, the bandwidth is increased proportionally, and the VoIP trunk service level (refer to Table 2) is measured based on a total bandwidth being available (e.g. 512 kbps for the headquarters).

TABLE 1

| | |
|---|---|
| G.723.1 6.3K | G.729A |

| Codec | Silence | Silence | Silence | Silence |
|---|---|---|---|---|
| Frame | Enable | Disable | Enable | Disable |
| 1 | 8.3K | 20.8K | 20.5K | 51.2K |
| 2 | 5.4K | 13.6K | 11.8K | 29.6K |
| 3 | 4.9K | 11.2K | 9.0K | 22.4K |
| 4 | 4.4K | 10.9K | 7.5K | 18.8K |
| 5 | 3.7K | 9.3K | 6.6K | 16.6K |
| 6 | 3.5K | 8.8K | 6.1K | 15.2K |
| 7 | | | 5.6K | 14.1K |
| 8 | | | 5.4K | 13.4K |
| 9 | | | 5.1K | 12.8K |
| 10 | | | 4.9K | 12.3K |

TABLE 2

| VoIP Trunk | |
|---|---|
| Service Level | Standard (VoIP bandwidth usage: %) |
| 3 | Below 50% |
| 2 | Greater than or equal to 50% and Below 70% |
| 1 | Greater than or equal to 70% and Below 80% |
| 0 | Greater than or equal to 80% and Below 90% |

As shown in Table 2, when the VoIP bandwidth usage is below 50%, the VoIP trunk service level is 3, far from being busy, to be more specific, in a light traffic state where the VoIP call service is yet available.

In this case, the class of VoIP service per subscriber discussed above or the class of VoIP service according to the type of call that is going to be discussed later does not need to be considered. As such, selective call setup is not required, and all VoIP calls being required can be covered.

If the VoIP bandwidth usage is greater than or equal to 50%, but below 70%, the VoIP trunk service level is 2, a little closer to a busy state.

In this case, the class of VoIP service per subscriber discussed above or the class of VoIP service according to the type of call that is going to be discussed later should be considered. As the traffic is being increased, selective call connection is required.

With respect to the class of service, only one or both VoIP service class per subscriber and VoIP service class according to the type of call can be considered at the same time.

If the VoIP bandwidth usage is greater than or equal to 70%, but below 80%, the VoIP trunk service level is 1, a busy state.

In this case, to reduce phone rates, only VoIP calls of high ranks in the class of VoIP service per subscriber discussed above or in the class of VoIP service according to the type of call that is going to be discussed later are covered.

With respect to the class of service, only one or both VoIP service class per subscriber and VoIP service class according to the type of call can be considered at the same time.

If the VoIP bandwidth usage is greater than or equal to 80%, but below 90%, the VoIP trunk service level is 0, a very busy state or heavy traffic state. In this state, a great deal of VoIP call services is being already provided.

To reduce phone rates in the heavy traffic state, only VoIP calls of the highest rank in the class of VoIP service per subscriber discussed above or in the class of VoIP service according to the type of call that is going to be discussed later are covered.

Another option to reduce phone rates in the heavy traffic state is to cover only VoIP calls that satisfy requirements of both VoIP service class per subscriber and VoIP service class according to the type of call.

Each of the PBXs 110, 120 and 130 methodizes VoIP calls in the order of cost-reduction effect, namely international calls>long-distance calls>headquarters-to-branch calls, and distinguishes the class of service according to the type of call. Table 3 illustrates available VoIP trunk service levels in each class according to the type of call.

TABLE 3

| | Available VoIP |
|---|---|
| VoIP Call Type | Trunk Service Levels |
| 0 (International calls) | 0, 1, 2, 3 |
| 1 (Long-distance calls) | 1, 2, 3 |
| 2 (Headquarter-to-Branch calls) | 2, 3 |

As shown in Table 3, available VoIP trunk service levels for international calls are 0, 1, 2 and 3. If there is a margin of the VoIP trunk, a VoIP bandwidth can be assigned at any time to connect calls.

Next, available VoIP trunk service levels for long-distance calls are 1, 2 and 3. Provided that the VoIP trunk service level having the VoIP bandwidth usage below 90% is 0, subscribers can make calls only through the PSTN network.

Lastly, available VoIP trunk service levels for headquarters-to-branch calls are 2 and 3. Provided that the VoIP trunk service level having the VoIP bandwidth usage below 90% is 0, and that the VoIP trunk service level having the VoIP bandwidth usage below 80% is 1, subscribers can make calls only through the PSTN network.

At any rate, VoIP calls are increased proportionally to international and long-distance calls originated by the subscribers. As such, the VoIP traffic as well as the VoIP service level is changed.

If that happens, it is not going to be easy for the subscribers to use the VoIP service any more, and they will have to compete against each other for limited VoIP trunk ports.

Unfortunately, to maximize cost-reduction having limited VoIP trunk ports according to VoIP service environments, the existing sequential servicing method is not the best option to meet the VoIP call service request.

Therefore, it is necessary to measure VoIP service based on an occupancy rate of bandwidth per VoIP call, and classify the class of subscriber or available service level per call type, and assign a VoIP trunk according to the VoIP service level being measured.

Table 4 is the list of available VoIP trunk service levels according to different class of VoIP service per subscriber.

TABLE 4

| Subscriber VoIP | Available VoIP Trunk |
|---|---|
| Service Class | Service Levels |
| 0 | 0, 1, 2, 3 |
| 1 | 1, 2, 3 |
| 2 | 2, 3 |
| 3 | 3 |

Each of the PBXs 110, 120 and 130 defines the class of VoIP call service per subscriber. For instance, the class of service for subscribers who make international and long-distance calls frequently is ‘0’ (e.g. Export Dept.), and the class of service for subscribers who make long-distance calls frequently is ‘1’ (e.g. Domestic Marketing Dept.).

In addition, the class of service for subscribers who make long-distance calls between the headquarters and a branch for most of time is ‘2’ (e.g. Manufacture Management Dept.). Lastly, the class of service for other subscribers is ‘3’.

If the class of VoIP service of a subscriber is 0, this means the subscriber, probably in Export Dept., makes a lot of international calls. Because PSTN-based calls are expensive in this case, the subscriber can reduce phone rates by calling over the VoIP network.

Next, if the class of VoIP service of a subscriber is 1, this means the subscriber, probably in Domestic Marketing Department, makes a lot of long-distance calls. Compared to international calls, long-distance calls are inexpensive. Hence, available service levels for the Domestic Market Department are limited, compared to the ones for the Export Department. The subscriber can make VoIP calls when the VoIP trunk service level is 1, 2 or 3.

If the class of VoIP service of a subscriber is 2, this means the subscriber, probably in Manufacture Management Department, makes a lot of long-distance calls between the headquarters and branches. Hence, available service levels for the Manufacture Management Department are even more limited than the ones for the Export Department. The subscriber can make VoIP calls when the VoIP trunk service level is 2 or 3.

Lastly, if the class of VoIP service of a subscriber is 3, this means the subscriber is probably involved in other kinds of work. The service area is very limited in this case, and the subscriber can make VoIP calls only when the VoIP trunk service level is 3.

Although the VoIP trunk service level is divided into 4 kinds, i.e. 0, 1, 2 and 3, it can be specified further.

Similarly, although the class of VoIP service per subscriber is categorized by department, other kinds of categories can also be used. Moreover, the class of service can be specified further.

In particular, the class of VoIP service for international calls can be graded according to country. The class of VoIP service for long-distance calls can also be specified further.

VoIP calls can be limited or permitted, on the basis of not only the class of VoIP service per subscriber, but also the class of VoIP service per call type. After all, these two standards are used for limiting or permitting calls.

VoIP trunk service level can be graded in terms of enhancing work efficiency of a company and other factors. If there is any one who wants a better voice quality, he/she may be allowed to set a call over the PSTN.

In short, the PBX can divide service level and class of service based on more diverse categories, in consideration of cost-reduction and more effective business activities.

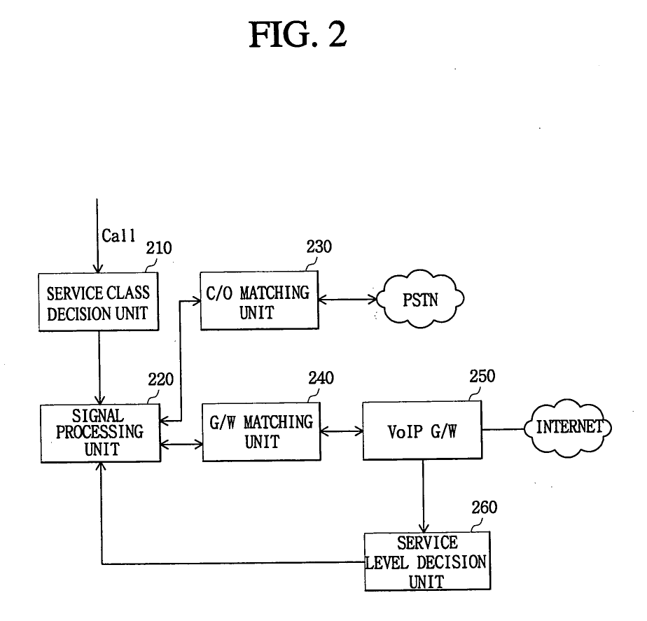

FIG. 2 is a schematic diagram of a VoIP call control apparatus in a PBX according to an exemplary embodiment of the present invention.

Referring to FIG. 2, the VoIP call control apparatus in a PBX includes a service class decision unit 210, a signal processing unit 220, a C/O matching unit 230, a G/W matching unit 240, a VoIP gateway 250, and a service level decision unit 260.

If a subscriber requests a call connection, the service class decision unit 210 looks up the class of service of a subscriber listed in the pre-stored subscriber service class table, and outputs the class of service to the signal processing unit 220.

The service class decision unit 210 decides the class of service, conforming to the pre-stored service class table per call type, and outputs the class of service to the signal processing unit 220.

In addition, when the subscriber requests a call connection, the service class decision unit 210 looks up the subscriber service class table to find out the class of service of the subscriber, and outputs the result to the signal processing unit 220. Also, the service class unit 210 decides class of the service by looking up the service class table per call type, and outputs the result to the signal processing unit 220.

The signal processing unit 220 stores the VoIP service class table per call type (Table 3) or the VoIP service class table per subscriber (Table 4). Referring to the VoIP service class tables, the service level of the current VoIP trunk from the service level decision unit 260 and the class of service from the service class decision unit 210 are searched. Then the signal processing unit 220 transfers a call to the PSTN network through the C/O matching unit 230, or to the VoIP gateway and eventually the IP network through the C/O matching unit 230, conforming to the search result.

The signal processing unit 220 can decide where to transmit the call, in consideration of one or both of the VoIP service class table per call type and the VoIP service class table per subscriber.

The C/O matching unit 230 is connected to both PBX and PSTN network, matching these two. Similarly, the G/W matching unit 240 is connected to both PBX and VoIP gateway 250, matching these two.

The VoIP gateway 250 connected to the G/W matching unit 240 is a device for protocol matching with respect to an outgoing call from the PBX. It is connected to a call receiver over the Internet, and provides the call receiver with a voice call according to the VoIP protocol.

The service level decision unit 260 accumulates bandwidth proportionally to VoIP calls being serviced, and decides the service level of VoIP trunk based on the occupancy rate of the accumulated bandwidth out of the total bandwidth. Then the service level decision unit 260 outputs the service level of VoIP trunk to the signal processing unit 220.

More details on the operation of the VoIP call control apparatus in the PBX are provided below.

Each PBX assigns a network bandwidth as shown in Table 1. For example, Silence Enable is assigned to G723.1 codec, and 8.3 kbps is assigned to the Multiframe 1 environment. Every time a VoIP call is connected, the service level decision unit 260 accumulates bandwidth proportionally to VoIP calls being serviced, and measures the service level of VoIP trunk based on the occupancy rate of the accumulated bandwidth out of total bandwidth being available (e.g. 512 kbps for the headquarters), as shown in Table 2. Then the service level decision unit 260 outputs the service level of VoIP trunk being measured to the signal processing unit 220.

For instance, suppose that the total bandwidth available for the headquarters is 512 kbps. If the currently accumulated bandwidth is 332 kbps, the occupancy rate is 64%. As such, the service level decision unit 260 concludes that the service level of the VoIP trunk is ‘2’, and transfers this level ‘2’ to the signal processing unit 220.

The service class decision unit 210 has the service class table per subscriber or the service class table per call type. Hence, when there is a call connection request, the service class decision unit 210 looks up each of the service class tables to find out an appropriate service class with respect to the call connection request, and transfers the service class to the signal processing unit 220.

For instance, if a subscriber in the Manufacture Management Department sends a call connection request, the service class decision unit 210 looks up the VoIP service class table per subscriber, and gives the subscriber the class ‘2’. Then, the service class decision unit 210 transfers the class to the signal processing unit 220. In like manner, if a subscriber in the headquarters sends a call connection request, the service class decision unit 210 looks up the VoIP service class table per call type, and gives the subscriber the class ‘2’. Then, the service class decision unit 210 transfers the class to the signal processing unit 220.

As discussed before, the service class decision unit 210 can make a decision on the service class, referring to both of the VoIP service class table per subscriber and the VoIP service class table per call type. Suppose that a subscriber in Export Department sends a call connection request. Then, the service class decision unit 210 outputs the VoIP service class of the subscriber as ‘0’ based on what is in the VoIP service class table per subscriber. On the other hand, if the subscriber wants to call to another branch, the service class decision unit 210 outputs the VoIP service class of the call type as ‘2’ based on what is in the VoIP service class table per call type. The service class result is transferred to the signal processing unit 220.

Now referring to one of the VoIP service class table per subscriber (Table 3) and the VoIP service class table per call type (Table 4), the signal processing unit 220 decides whether the service class provided by the service class decision unit 210 is qualified for a VoIP service in the VoIP trunk service level provided by the service level decision unit 250.

If yes, the signal processing unit 220 transfers the call to the G/W matching unit 240, but if not, the signal processing unit 220 transfers the call to the PSTN network via the C/O matching unit 210.

As an example, suppose that the service level transmitted from the service level decision unit 260 is 2 and that the VoIP service class of the subscriber transmitted from the service class decision unit 210 is 2. Since a VoIP service can be provided in this case, the signal processing unit 220 transfers a call through the G/W matching unit 240. Meanwhile, if the VoIP service class of the subscriber is 3 while the service level is being 2, a VoIP service cannot be provided. Thus the signal processing unit 220 transfers the call to the PSTN network via the C/O matching unit 230.

As another example, suppose that the service level transmitted from the service level decision unit 260 is 1 and that the VoIP service class of the call in question transmitted from the service class decision unit 210 is also 1. Since a VoIP service can be provided in this case, the signal processing unit 220 transfers the call through the G/W matching unit 240. Meanwhile, if the VoIP service class of the subscriber is 2 while the service level is being 1, a VoIP service cannot be provided. Thus the signal processing unit 220 transfers the call to the PSTN network via the C/O matching unit 230.

Next, suppose that the service level transmitted from the service level decision unit 260 is 1, the VoIP service class of the subscriber transmitted from the service class decision unit 210 is 1, and the VoIP service class of the call in question is 1. Since a VoIP service can be provided according to the VoIP service class of the subscriber, and the call connection is also possible according to the VoIP service of the call in this case, the signal processing unit 220 transfers the call through the G/W matching unit 240.

Also suppose that the service level transmitted from the service level decision unit 260 is 1, the VoIP service class of the subscriber transmitted from the service class decision unit 210 is 1, and the VoIP service class of the call in question is 2. In this case, a VoIP service can be provided as long as the VoIP service class of the subscriber is 1 while the service level is being 1. However, the VoIP service cannot be provided if the VoIP service class of the call is 2 while the service level is being 1. Thus the signal processing unit 220 transfers the call to the PSTN network via the C/O matching unit 230.

The VoIP gateway 250 converts the call transmitted through the G/W matching unit 240 into an appropriate signal for the VoIP protocol, and transfers the converted signal to the IP network.

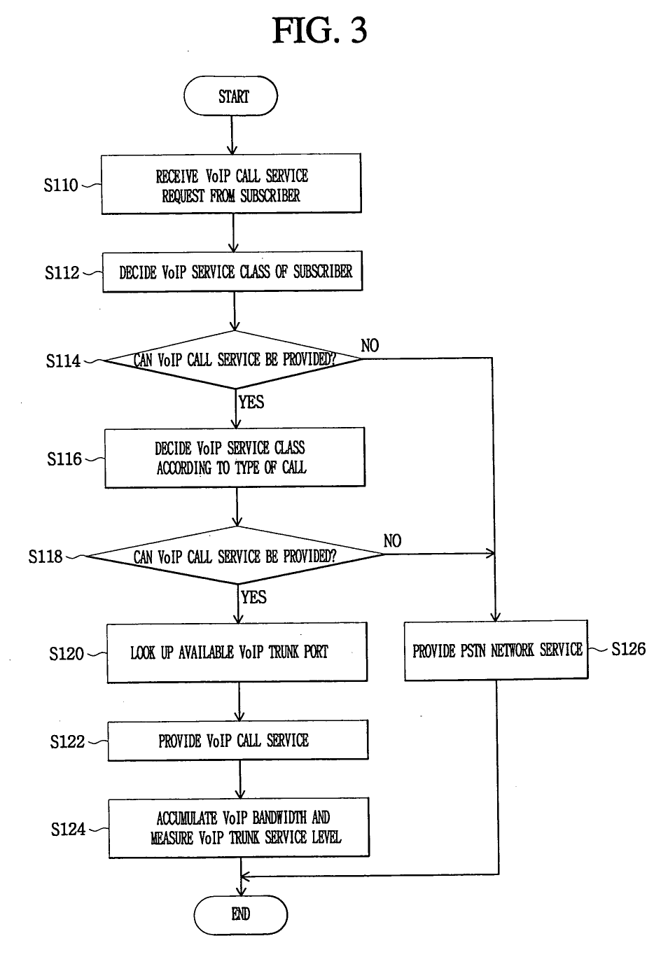

FIG. 3 is a flow chart describing a method for controlling VoIP calls in a PBX according to an exemplary embodiment of the present invention.

Referring to FIG. 3, the method for controlling a VoIP call in a PBX is largely divided into three parts: one is to decide the service class (S110, 112, and 116), another is to decide whether a VoIP service can be provided in a service level in question (S114 and 118), and the other is to provide the VoIP service (S120, 122, 124, and 126).

At first, when the PBX receives a VoIP call service request from a subscriber (S110), it decides the VoIP service class by referring to the VoIP service class table per subscriber (S112).

Next, it is decided whether a VoIP service can be provided in a VoIP trunk service level corresponding to the VoIP service class of the subscriber (S114).

If the VoIP service can be provided in a VoIP trunk service level corresponding to the VoIP service class of the subscriber, a VoIP service class for the call in question is decided, referring to the VoIP service class table per call type (S116).

If the VoIP service cannot be provided in a VoIP trunk service level corresponding to the VoIP service class of the subscriber, however, a voice call service is provided through the PSTN network instead (S126).

On the other hand, it is decided whether a VoIP call service can be provided in a VoIP trunk service level corresponding to the VoIP service class of the call (S118). If yes, an available VoIP trunk port is looked up (S120), and the VoIP call service is provided through the available VoIP trunk port (S122). On the contrary, if the VoIP service cannot be provided in a VoIP trunk service level corresponding to the VoIP service class of the call, a voice call service is provided through the PSTN network instead (S126).

Afterwards, a network bandwidth assigned to provide a VoIP call service is accumulated, and the service level of a VoIP trunk is measured according to the occupancy rate of the accumulated bandwidth out of the total bandwidth (S124).

In conclusion, according to the present invention, a relatively more cost-effective VoIP trunk can be advantageously used in a PBX having PSTN trunk and VoIP trunk.

In addition, it is possible to control cost-effective VoIP call service by selectively providing the service according to the class of service of the subscriber.

Further, it is possible to control cost-effective VoIP call service by selectively providing the service according to the type of call (e.g. international call, long-distance call, or headquarters-to-branch call).

While the present invention has been particularly shown and described with reference to exemplary embodiments thereof, it will be understood by those skilled in the art that the foregoing and other changes in form and details may be made therein without departing from the spirit and scope of the present invention.

What is claimed is:

1. A voice over Internet protocol call control apparatus in a voice over Internet protocol private branch exchange, the apparatus comprising:
a service class decision unit for receiving a voice over Internet protocol call service request from a subscriber, deciding a service class for indicating priority of a voice over Internet protocol call service, and outputting the service class;
a service level decision unit for measuring band width usage of the voice over Internet protocol trunk, deciding a service level according to the band width usage so as to determine which service classes can use the voice over Internet protocol call service, and outputting the service level; and
a signal processing unit for deciding whether the voice over Internet protocol call with the service class transmitted from the service class decision unit can be serviced in the service level of the voice over Internet protocol trunk transmitted from the service level decision unit, and when the voice over Internet protocol call is serviceable, providing a voice over Internet protocol call service and when the voice over Internet protocol call is not serviceable, providing a voice call service over the public switched telephone network.

2. The apparatus according to claim 1, wherein the service level decision unit accumulates a bandwidth every time a voice over Internet protocol call service is provided, and decides the service level of the voice over Internet protocol trunk according to an occupancy rate of the accumulated bandwidth out of total bandwidth.

3. The apparatus according to claim 1, wherein the service class decision unit decides the class of service by referring to a voice over Internet protocol service class table per subscriber according to a characteristic of the subscriber.

4. The apparatus according to claim 3, wherein the voice over Internet protocol service class table per subscriber reflects characteristics of each department in a company.

5. The apparatus according to claim 1, wherein the service class decision unit decides the class of service by referring to a voice over Internet protocol service class table per call type according to a type of the call.

6. The apparatus according to claim 5, wherein the voice over Internet protocol service class table per call type reflects characteristics of each call.

7. The apparatus according to claim 1, wherein the service class decision unit decides the class of service by referring to both a voice over Internet protocol service class table per subscriber according to a characteristic of the subscriber and a voice over Internet protocol service class table per call type according to a characteristic of the call requested.

8. The apparatus according to claim 7, wherein the voice over Internet protocol service class table per subscriber is prepared based on characteristics of each department in a company, and the voice over Internet protocol service class table per call type is prepared based on characteristics of each call.

9. The apparatus according to claim 1, wherein the service class decision unit decides the class of service by referring to cost for a voice over Internet protocol service of the call.

10. The apparatus according to claim 1, further comprising:
a central office matching unit for matching a public switched telephone network and the private branch exchange;
a voice over Internet protocol gateway for performing a protocol matching process with respect to an outgoing call from the private branch exchange, and providing a voice call conforming to voice over Internet protocol; and
a gateway matching unit for matching the voice over Internet protocol gateway and the private branch exchange.

11. A voice over Internet protocol call control method in a private branch exchange, the method comprising the steps of:
in the private branch exchange, when a subscriber sends a voice over Internet protocol call service request, deciding a voice over Internet protocol service class;
deciding whether the voice over Internet protocol call service can be provided in a voice over Internet protocol trunk service level corresponding to the voice over Internet protocol service class;
when the voice over Internet protocol call service cannot be provided, providing a voice call service through a public switched telephone network, and when the voice over Internet protocol call service can be provided, looking up an available voice over Internet protocol trunk port and providing the voice over Internet protocol call service through the voice over Internet protocol trunk; and
when providing the voice over Internet protocol call service, changing the voice over Internet protocol trunk service level.

12. The method according to claim 11, wherein the private branch exchange decides the service class by referring to a voice over Internet protocol service class table per subscriber according to a characteristics of the subscriber.

13. The method according to claim 11, wherein the private branch exchange decides the service class by referring to a voice over Internet protocol service class table per call type according to a characteristic of the call.

14. The method according to claim 11, wherein the private branch exchange decides the service class by referring to both a voice over Internet protocol service class table per subscriber according to a characteristics of the subscriber and a voice over Internet protocol service class table per call type according to a characteristic of the call.

15. The method according to claim 11, wherein the voice over Internet protocol trunk service level is decided based on an occupancy rate of a bandwidth out of a total bandwidth, the bandwidth being accumulated every time a voice over Internet protocol call service is provided.

16. An apparatus comprising:
a first unit receiving a voice over Internet protocol call service request from a subscriber, deciding a service class, and outputting the service class;
a second unit measuring a service level of a voice over Internet protocol trunk and outputting the service level;
a third unit matching a public switched telephone network and a private branch exchange;
a fourth unit performing a protocol matching process with respect to an outgoing call from the private branch exchange, and providing a voice call conforming to voice over Internet protocol;
a fifth unit matching the fourth unit and the private branch exchange; and
a sixth unit deciding whether the voice over Internet protocol call with the service class transmitted from the first unit can be serviced or established in a service level of the voice over Internet protocol trunk decided in the service level transmitted from the second unit, and when the voice over Internet protocol call is serviceable, providing a voice over Internet protocol call service through the fifth unit and the fourth unit, and when the voice over Internet protocol call is not serviceable, providing a voice call service over the public switched telephone network via the third unit.

17. The apparatus according to claim 16, wherein the second unit accumulates a bandwidth every time a voice over Internet protocol call service is provided, and decides the service level of the voice over Internet protocol trunk according to an occupancy rate of the accumulated bandwidth out of a total bandwidth.

18. The apparatus according to claim 16, wherein the first unit decides the class of service by referring to a voice over Internet protocol service class table per subscriber according to a characteristic of the subscriber.

19. The apparatus according to claim 18, wherein the voice over Internet protocol service class table per subscriber reflects characteristics of each group of subscribers from a plurality of groups of subscribers.

20. The apparatus according to claim 16, wherein the first unit decides the class of service by referring to a voice over Internet protocol service class table per call type according to a type of the call.

21. The apparatus according to claim 20, wherein the voice over Internet protocol service class table per call type reflects characteristics of each call.

22. The apparatus according to claim 16, wherein the first unit decides the class of service by referring to both a voice over Internet protocol service class table per subscriber according to a characteristic of the subscriber and a voice over Internet protocol service class table per call type according to a characteristic of the call requested.

23. The apparatus according to claim 22, wherein the voice over Internet protocol service class table per subscriber is prepared based on characteristics of each sub-group in a group comprising a plurality of the sub-groups, and the voice over Internet protocol service class table per call type is prepared based on characteristics of each call.

24. A method, comprising:
determining a service class, comprising of:
receiving a voice over Internet protocol call service request from a subscriber by way of a public branch exchange;
determining a voice over Internet protocol service class by referring to a voice over Internet protocol service class table per subscriber; and
determining the voice over Internet protocol service class for the call referring to the voice over Internet protocol service class table per call type when the voice over Internet protocol service can be provided in a voice over Internet protocol trunk service level corresponding to the voice over Internet protocol service class of the subscriber;
determining whether a voice over Internet protocol service can be provided in the service level, comprising of:
determining whether the voice over Internet protocol service can be provided in the voice over Internet protocol trunk service level corresponding to the voice over Internet protocol service class of the subscriber; and
determining whether the voice over Internet protocol call service can be provided in a voice over Internet protocol trunk service level corresponding to the voice over Internet protocol service class of the call; and
providing the voice over Internet protocol service, comprising of:
looking up an available voice over Internet protocol trunk port when the voice over Internet protocol call service can be provided in the voice over Internet protocol trunk service level corresponding to the voice over Internet protocol service class of the call;
providing the voice over Internet protocol call service through the available voice over Internet protocol trunk port; and
providing a voice call service through the public switched telephone network when the voice over Internet protocol service cannot be provided in the voice over Internet protocol trunk service level corresponding to the voice over Internet protocol service class of the call.

25. The method according to claim 24, wherein the voice over Internet protocol trunk service level is decided based on an occupancy rate of a bandwidth out of a total bandwidth, the bandwidth being accumulated every time a voice over Internet protocol call service is provided.
